(19) United States
(12) Patent Application Publication
(10) Pub. No.: US 2021/0148441 A1
(43) Pub. Date: May 20, 2021

(54) SEGMENTED LINEAR FORCE CONVERTER

(71) Applicant: Greg Matthew Davison, Itasca, IL (US)

(72) Inventor: Greg Matthew Davison, Itasca, IL (US)

(21) Appl. No.: 16/687,654

(22) Filed: Nov. 18, 2019

(51) Int. Cl. F16H 21/12

(52) U.S. Cl. CPC F16H 21/12

(57) ABSTRACT

A machine for the conversion of segmented linear force into rational force around a fulcrum at a mechanical advantage to an included or attached drive mechanism. A body consisting of pivot arms, drive mechanism, primary shaft, and bearings. With the pivot arms bolted around standard bearings that are attached to a primary stationary primary shaft a mechanical advantage of a pulley is created to an included or attached drive mechanism. The segmented linear force in this application includes, but is not limited to, an electromagnetic force or compressed air or manual labor. A machine that converts segmented linear force at a mechanical advantage directly to an incorporated or attached drive mechanism such as a gear, pulley, or drive secondary shaft.

### BACKGROUND

### 1. Field of the Invention

Segmented Linear Force Converter is in the field of mechanical devices or machines. This machine is design to take harness the mechanical advantage of a pulley.

### 2. Description of Prior Art

Existing rotational driven shaft technology is focused on the rotation of a primary shaft to either drive, or to drive an attached drive mechanism which performs the work.

This machine keeps the primary shaft stationary while allowing the pivot arms and outer shell of the bearings with the included or attached drive mechanism to rotate. With the pivot arms being of lower mass and larger extended and implied diameter than the other components, resistance to rotation is decreased. Utilizing the same segmented linear force, but harnessing the lower mass of the pivot arms and the increased extended and implied diameter of the pivot arms around a stationary primary shaft by means of bearings, the torque is increased.

### SUMMARY

The objective of the Segmented Linear Force Converter is to include pivot arms to take advantage of the force that a pulley has around a fulcrum. With the pivot arms bolted together around bearings which are attached around a stationary shaft, the pivot arms being of a larger extended and implied diameter than the drive mechanism, it transfers a mechanical advantage of a pulley to force a rotational direction on the drive mechanism which is included or attached. The force applied on the pivot arms is multiplied through the mechanical advantage of a pulley. Although the individual pivot arms are flat in shape, the orbit of the pivot arms acts as a pulley with an extended and implied diameter, towards the drive mechanism.

### DETAILED DESCRIPTIONS

BEARINGS 1: Bearing races with balls inserted to reduce the amount of friction of one object to another.

PRIMARY SHAFT 2: A round rod used as a fulcrum or pivot point for rotational force.

PIVOT ARMS 3: Formed out of a single piece each or 3-D printed, or of segmented parts. Specifically shaped to be fastened to be held in orbit around a stationary primary shaft 2 by means of bolts 6 and bearings 1 with an included drive mechanism 4 such as a gear, pulley, or a secondary shaft at a mechanical advantage to the drive mechanism 4.

DRIVE MECHANISM 4: A pulley, or a gear, or a secondary shaft.

HOLDING FRAME 5: A brace that holds the shaft in position and keep it from turning.

BOLTS 6: Standard bolts. A fastening device.

### FIGURES

FIG. 1 Illustrates a standard bearing 1.

FIG. 2 Illustrates two bearings 1 mounted on a primary shaft 2.

FIG. 3 Illustrates 1 of 2 pivot arms 3 showing the way that the pivot arms 3 encase the bearings 1 holding them in orbit around the stationary primary shaft 2.

FIG. 4 Illustrates both pivot arms 3 fastened in place with bolts 6 around the bearings 1 in orbit around the stationary primary shaft 2 with the attached or included drive mechanism 4.

FIG. 5 Illustrates the holding frames 5 supporting the primary shaft 2 in a stationary position to keep it from rotating. Also illustrates the included or attached drive mechanism 4. (pulley, secondary shaft, or gear)

FIG. 6 Illustrates the extended and implied diameter of the pivot arms 3.

FIG. 7 Illustrates the segmented linear force as it is applied to the pivot arms 3 which includes, but is not limited to, electromagnetic force, compressed air pressure, or manual force.

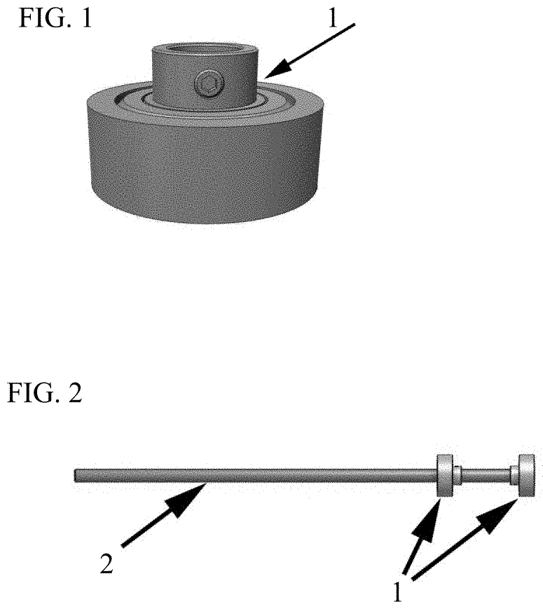

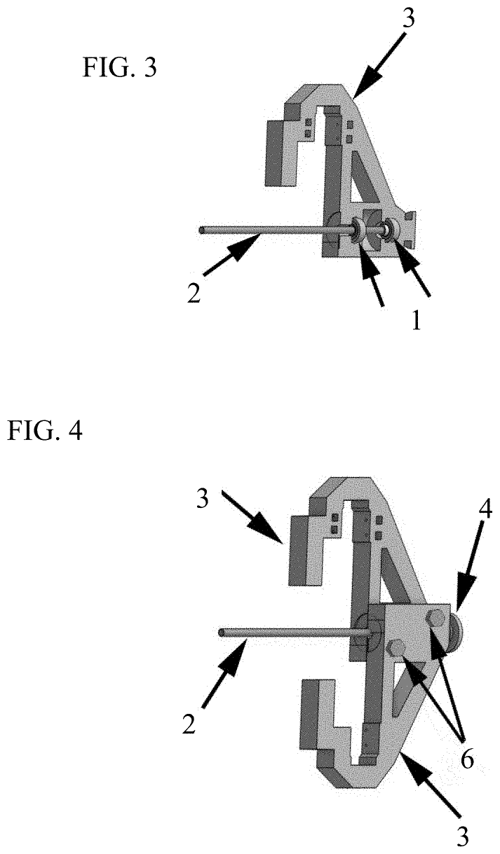

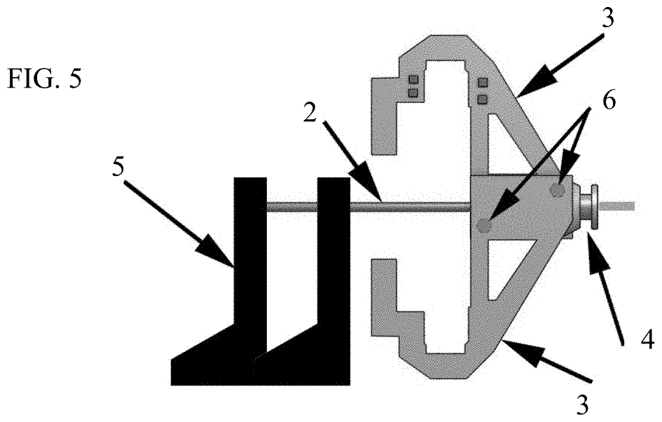

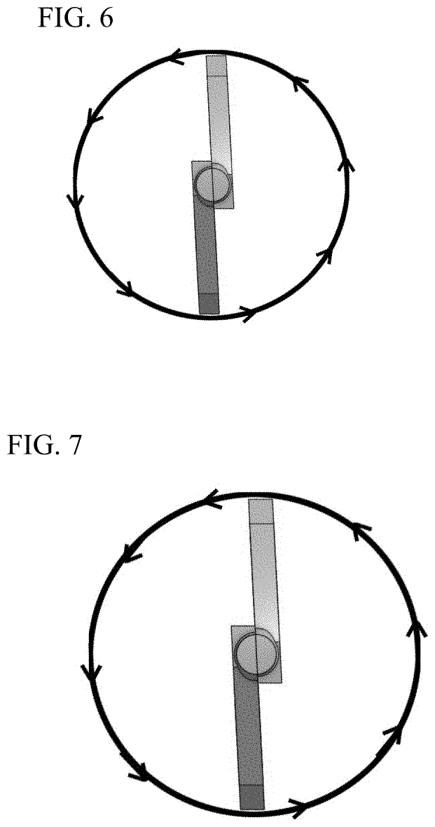

### PREFERRED EMBODIMENTS

Each Pivot Arm is to be shaped out of single piece of aluminum, either cast, milled, or 3d printed fastened together with bolts that has an included or attached drive mechanism such as a gear, pulley, or secondary shaft.

What is claimed:

1. A machine for the conversion of segmented linear force using the extended and implied furthest outside diameter of pivot arms in orbit around a stationary primary shaft. When segmented linear force is applied to the torque to the pivot arms which rotate around a stationary primary shaft by means of standard bearings. The pivot arms have a drive mechanism incorporated or attached concentric to the center of the fulcrum, such as but not limited to a pulley, gear, or a secondary shaft. By applying segmented linear force to the pivot arms, it causes them to rotate around a stationary primary shaft, diverting the force segmented linear force directly through the pivot arms to the included or attached drive mechanism. This provides greater torque to the included or attached drive mechanism than if the force was applied directly to the primary shaft.
